(19) United States
(12) Patent Application Publication
(10) Pub. No.: US 2003/0057796 A1
(43) Pub. Date: Mar. 27, 2003

(54) Modularized stator

(76) Inventors: Chia-Hao Fan, Taipei (TW); Yu-Fang Fan, Taipei (TW)

Correspondence Address: BACON & THOMAS, PLLC, 625 SLATERS LANE, FOURTH FLOOR, ALEXANDRIA, VA, 22314

(21) Appl. No.: 10/251,978

(22) Filed: Sep. 23, 2002

(30) Foreign Application Priority Data
Sep. 26, 2001 (TW) 90216435

(51) Int. Cl. H02K 1/00

(52) U.S. Cl. 310/216

(57) ABSTRACT

A modularized stator is disclosed, which includes a base made of magnetically conductive material, and a plurality of iron core modules fixedly fastened to respective recessed locating holes on the base. Each iron core module is formed of an iron core made of magnetically conductive material, an electrically insulative bushing sleeved onto the iron core, and a winding wound round the electrically insulative bushing.

### BACKGROUND OF THE INVENTION

1. Field of the Invention

The present invention relates to a stator and, more particularly, to a modularized stator for use in a motor or generator.

2. Description of Related Art

A stator for motor or generator has a number of poles designed subject to the desired capacity and revolving speed. Conventionally, a stator is cast in unity, or made by riveting a plurality of iron plates or silicon steel plates of thickness 0.5 mm˜0.35 mm into a stack. When designed, a stator has a fixed number of poles. In case the number of poles is to be changed, the original equipment becomes useless, and a new molding is needed. Due to this problem, conventional stators have a high manufacturing cost.

Therefore, it is desirable to provide an air hole plug arrangement for clean container that eliminates the aforesaid drawbacks.

### SUMMARY OF THE INVENTION

It is the main object of the present invention to provide a modularized stator, which enables multiple iron core modules to be conveniently arranged on a magnetically conductive base to form one of a series of combinations. It is another object of the present invention to provide a modularized stator, which enables multiple iron core modules to be quickly installed in a magnetically conductive base so as to minimize the manufacturing cost of the stator.

To achieve these and other objects of the present invention, the modularized stator comprises a base made of magnetically conductive material, the base having a plurality of recessed locating holes on the top sidewall thereof, and a plurality of iron core modules respectively fixedly fastened to the recessed locating holes of the base. Each iron core module is comprised of an iron core made of magnetically conductive material, an electrically insulative bushing sleeved onto the iron core, and a winding wound round the electrically insulative bushing. The iron core of each iron core module has a top section terminating in a magnetic guide face, a bottom section fixedly fastened to one recessed locating hole of the base, and a middle section suspended in the electrically insulative bushing of the respective iron core module. The bushing can be made of plastics, Bakelite, or any of a variety of electrically insulative materials. Because of modularized design, the invention has an industrial value.

Other objects, advantages, and novel features of the invention will become more apparent from the following detailed description when taken in conjunction with the accompanying drawings.

### BRIEF DESCRIPTION OF THE DRAWINGS

FIG. 1 is an exploded view of a modularized stator constructed according to a first embodiment of the present invention.

FIG. 2 is an exploded view of an iron core module according to the first embodiment of the present invention.

FIG. 3 is a sectional view showing an application example of the first embodiment of the present invention.

FIGS. 4a˜4f show different alternate forms of iron cores according to the first embodiment of the present invention.

FIGS. 5a˜5f show six different iron cores press-molded from iron powder or directly made of a respective iron block according to the first embodiment of the present invention.

FIGS. 6a˜6c show different rotors adapted for use with the modularized stator of the first embodiment of the present invention.

FIG. 7 is an exploded view of a second embodiment of the present invention.

FIG. 8 shows different iron cores for the second embodiment of the present invention.

FIG. 9 show different rotors adapted for use with the modularized stator of the second embodiment of the present invention.

FIG. 10 is an exploded view of a modularized stator constructed according to a third embodiment of the present invention.

FIG. 11 is a sectional view showing the modularized stator with a rotor according to the third embodiment of the present invention.

FIG. 12 is a side view showing a modularized stator used with a rotor according to a fourth embodiment of the present invention.

FIG. 13 is an exploded view showing a modularized stator used with a rotor according to a fifth embodiment of the present invention.

FIG. 14a is an exploded view of an alternate form of the iron core module according to the first embodiment of the present invention.

FIG. 14b is an exploded view of another alternate form of the iron core module according to the first embodiment of the present invention.

FIG. 15 is a sectional view of a sixth embodiment of the present invention.

FIG. 16 is a sectional view of a seventh embodiment of the present invention.

FIG. 17 is a sectional view of an eighth embodiment of the present invention.

### DETAILED DESCRIPTION OF THE PREFERRED EMBODIMENT

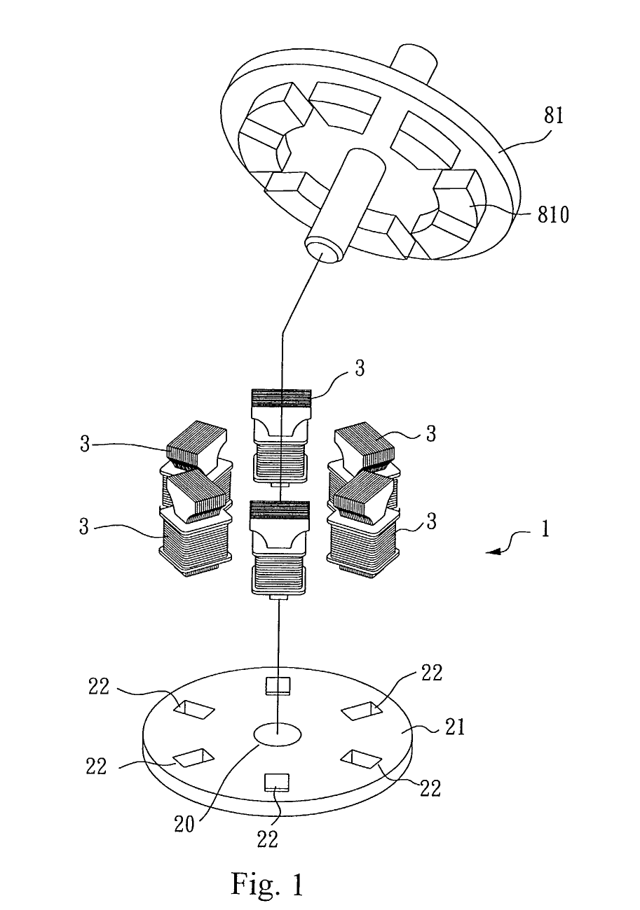

With reference to FIG. 1, a modularized stator in accordance with a first embodiment of the present invention is shown comprised of a base 21, and six iron core modules 3.

The base 21 is a disk-like member made of magnetically conductive metallic material having six recessed locating holes 22 equiangularly spaced on the top sidewall thereof. The six iron core modules 3 are respectively positioned in the recessed locating holes 22. The base 21 together with a rotor forms a motor.

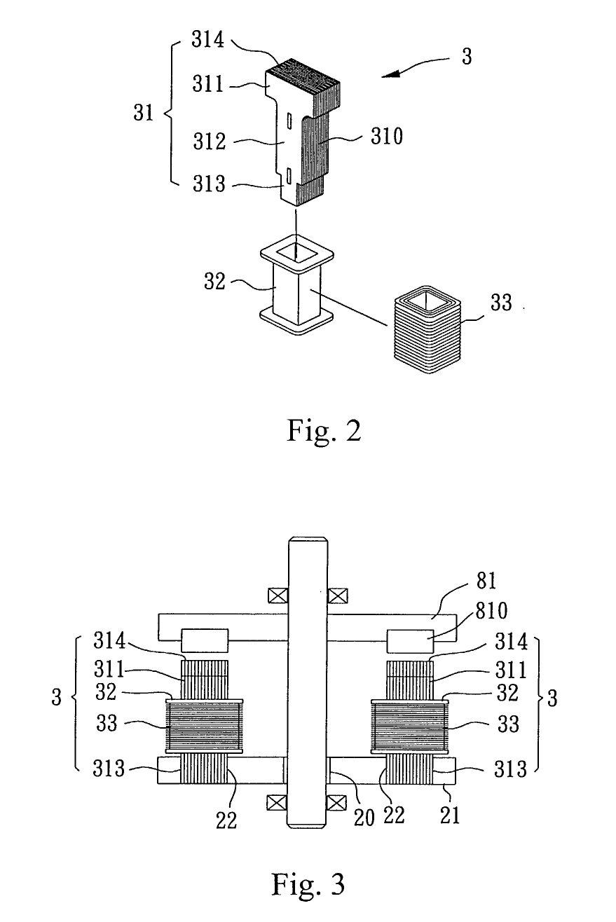

Referring to FIG. 2 and FIG. 1 again, each iron core module 3 is comprised of an iron core 31, an electrically insulative bushing 32, and a winding 33. The iron core 31 is comprised of a stack of silicon steel plates 310, having a top section 311 forming a magnetic guide face 314 axially extended in direction equal to the center shaft of the rotor 81 (see FIG. 1), a middle section 312 suspended in the electrically insulative bushing 32, and a bottom section 313. The bottom section 313 is a mounting section press-fitted into one recessed locating hole 22 of the base 21. Alternatively, the bottom section 313 can be fastened to one recessed locating hole 22 of the base 21 by a screw or lock pin, or directly welded to one recessed locating hole 22 of the base 21. Any of a variety of conventional mounting methods may be employed to fixedly secure the bottom section 313 to one recessed locating hole 22 of the base 21. The electrically insulative bushing 32 is molded from plastics, and sleeved onto the middle section 312 of the iron core 31. The winding 33 is wound round the bushing 32. When electric current is connected to the winding 33, a magnetic field is produced.

Referring to FIG. 1 again, the base 21 has a center through hole 20, which receives the center shaft of the rotor 81. The rotor 81 has a plurality of magnets 810 equiangularly spaced on the bottom sidewall thereof and adapted for acting with the iron core modules 3. The magnets 810 of the rotor 81 are disposed above the iron core modules 3 corresponding to the magnetic guide faces 314 of the iron cores 31 of the iron core modules 3.

Referring to FIG. 3, the center shaft of the rotor 81 is inserted through the center through hole 20 of the base 21, and the bottom sections 313 of the iron cores 31 of the iron core modules 3 are respectively fixedly fastened to the recessed locating holes 22 of the base 21.

As indicated, the modularized stator is comprised of a magnetic guide base 21 and a plurality of iron core modules 3 arranged on the magnetic guide base 21. The iron core modules 3 can easily quickly be installed in the magnetic guide base 21. This modularized stator design is inexpensive to manufacture.

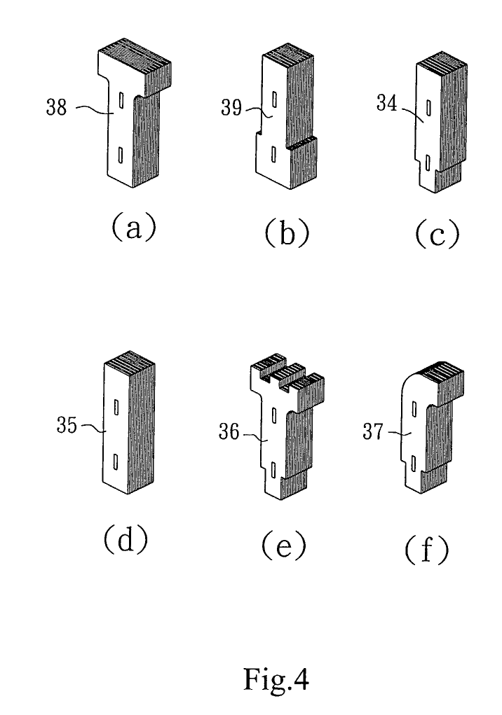

FIGS. 4a˜4f show six different alternate forms of iron cores 38, 39, 34, 35, 36, and 37. These alternate forms are for reference only. The iron cores of the iron modules 3 may have any of a variety of other shapes. Further, the iron cores of the iron modules 3 may be made from iron powder, or a respective iron block.

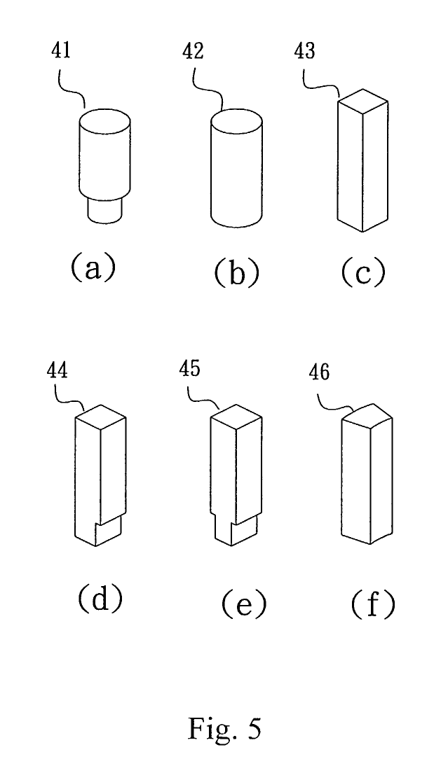

FIGS. 5a˜5f show six different iron cores 41, 42, 43, 44, 45, and 46 press-molded from iron powder or directly made of a respective iron block. This stator structure can be used another structure of rotor to form another motor.

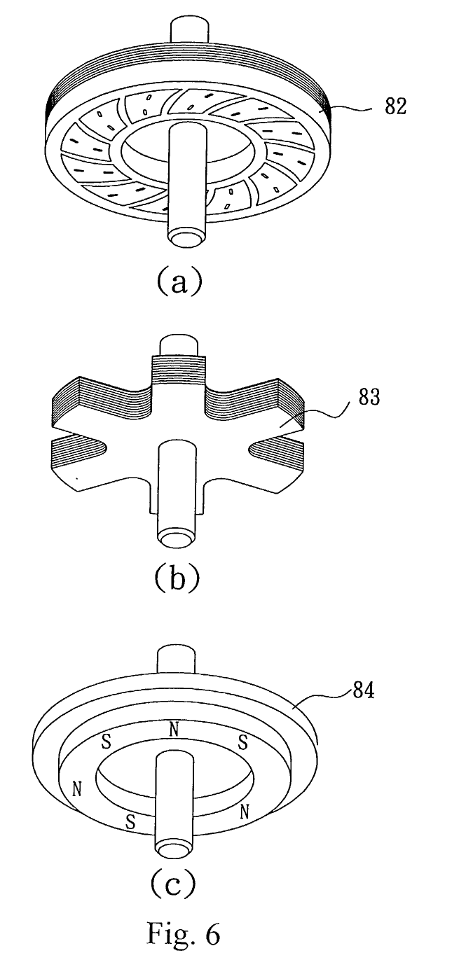

FIGS. 6a˜6c show different rotors for use with the modularized stator of the present invention. For example, the modularized stator of the present invention can be used with the aluminum cast rotor 82 of FIG. 6a to form an inductive motor, the salient pole rotor 83 of FIG. 6b to form a magnetic resistance motor, the rotor 84 of FIG. 6c to form a DC brushless motor, . . . etc.

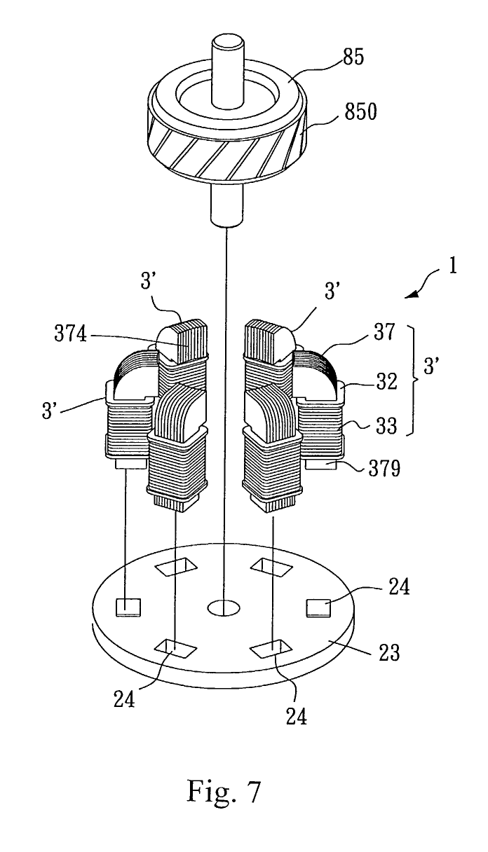

FIG. 7 shows a modularized stator constructed according to a second embodiment of the present invention. Basically, the modularized stator of this embodiment is similar to the aforesaid first embodiment of the present invention. However, the magnetic guide face 374 of each iron core module 3′ is arranged in radial direction, i.e., the iron core 37 of each iron core module 3′ faces the center shaft of the aluminum cast rotor 85. The aluminum cast rotor 85 is mounted in the space surrounded by the six iron core modules 3′, and the inductive magnetic pole 850 of the aluminum cast rotor 85 is disposed corresponding to the magnetic guide faces 374 of the iron cores 37 of the six iron core modules 3′. Because of modularized, this second embodiment achieves the same functions and effects of the aforesaid first embodiment.

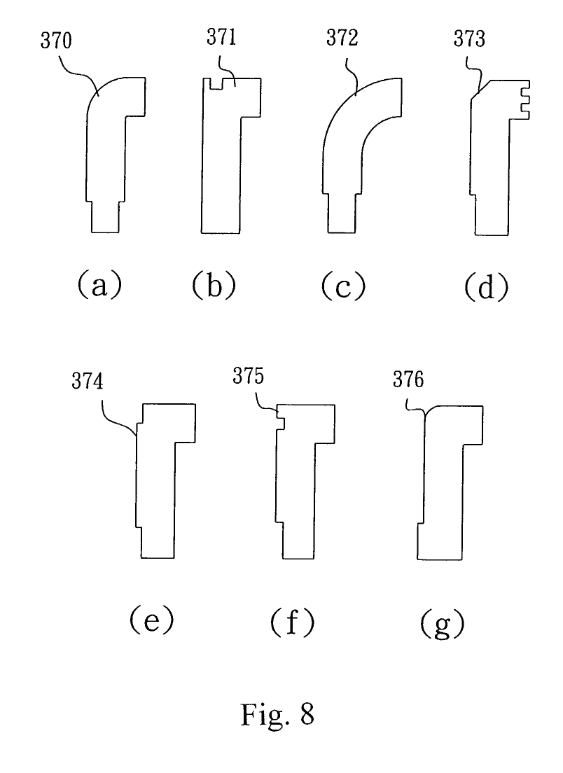

Referring to FIGS. 8a˜8f, the iron cores 37 are respectively formed of a stack of silicon steel plates 370, 371, 372, 373, 374, 375, and 376 of any of a variety of shapes. The modularized stator can be used with different rotors to form different types of motors.

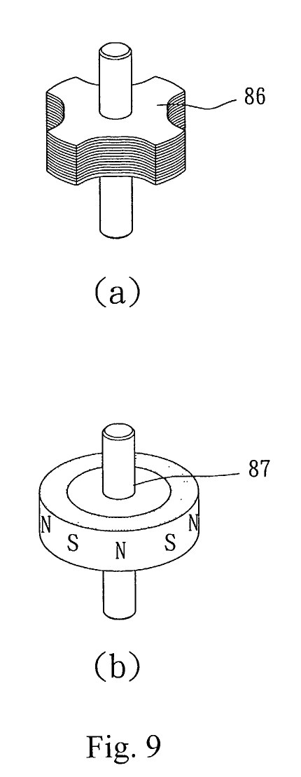

FIG. 9a shows a salient pole rotor 86 for use with the modularized stator of the second embodiment of the present invention to form a magnetic resistance motor. FIG. 9b shows a rotor 87 for use with the modularized stator of the second embodiment of the present invention to form a DC brushless motor.

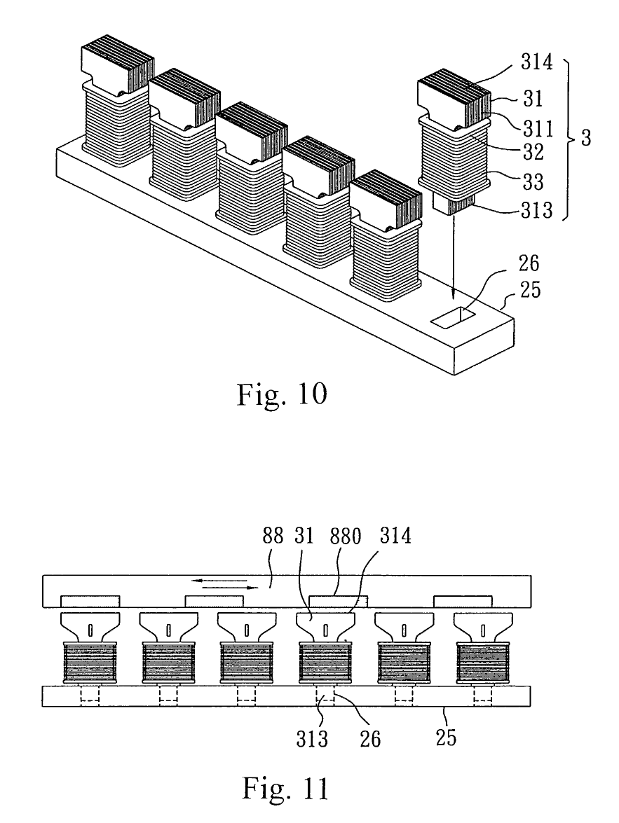

FIGS. 10 and 11 show a modularized stator constructed according to a third embodiment of the present invention for use with a rotor 88 to form a linear motor. According to this embodiment, the base 25 is a flat, elongated member, and the recessed locating holes 26 are equally spaced on the top sidewall of the base 25 and arranged in a line along the length of the base 25. The iron core modules 3 are same as that of the first embodiment of the present invention. The matched rotor 88 is an elongated member suspended above the iron core modules 3. The permanent magnets 880 of the rotor 88 are respectively disposed right above the magnetic guide faces 314 of the iron cores 31 of the iron core modules 3. Magnetic induction between the permanent magnets 880 of the iron cores 31 causes the elongated rotor 88 to make a linear motion.

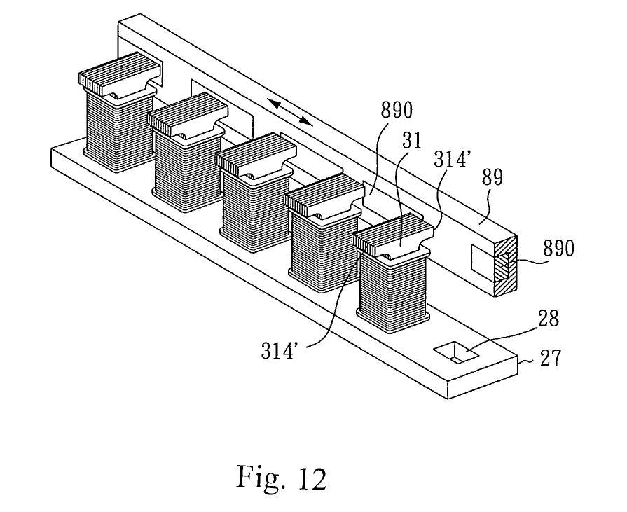

FIG. 12 shows a modularized stator constructed according to a fourth embodiment of the present invention for use with a rotor 89 to form a linear motor. According to this embodiment, the rotor 89 is disposed at one side, and the permanent magnets 890 of the rotor 89 are disposed corresponding to the magnetic guide faces 314′ of the iron cores 31. The magnetic iron cores 31 are fixedly fastened to the recessed locating holes 28 of the elongated base 27. Alternatively, two rotors may be used and arranged at two sides of the modularized stator.

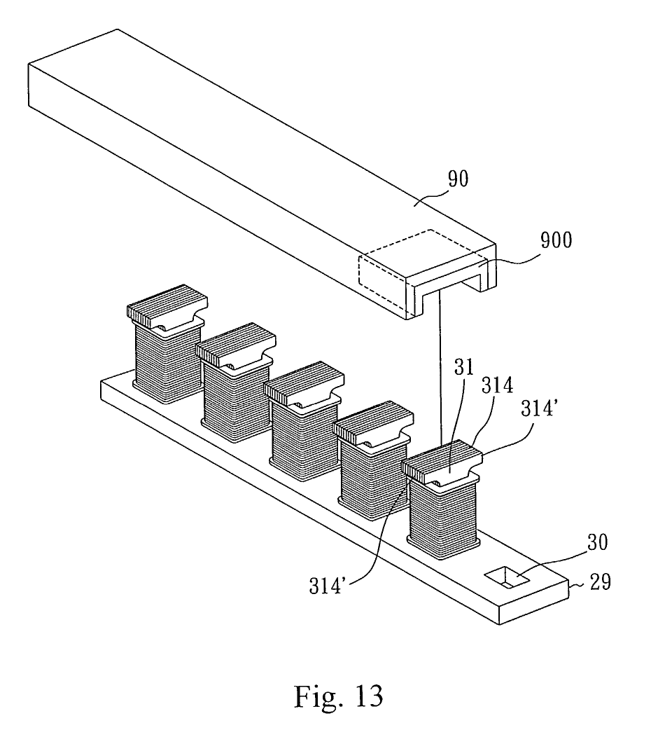

FIG. 13 shows a modularized stator constructed according to a fifth embodiment of the present invention for use with a rotor 90 to form a linear motor. According to this embodiment, the rotor 90 has a substantially reverse of U shaped cross section, and is suspended above the iron cores 31; the permanent magnets 900 have a substantially reverse of U shaped cross section, and are equally spaced on the inside wall of the rotor 90 corresponding to the three magnetic guide faces 314,314′ of each of the iron cores 31 in the recessed locating holes 30 of the elongated base 29. This design greatly enhances the induced magnetic force and the motor capacity.

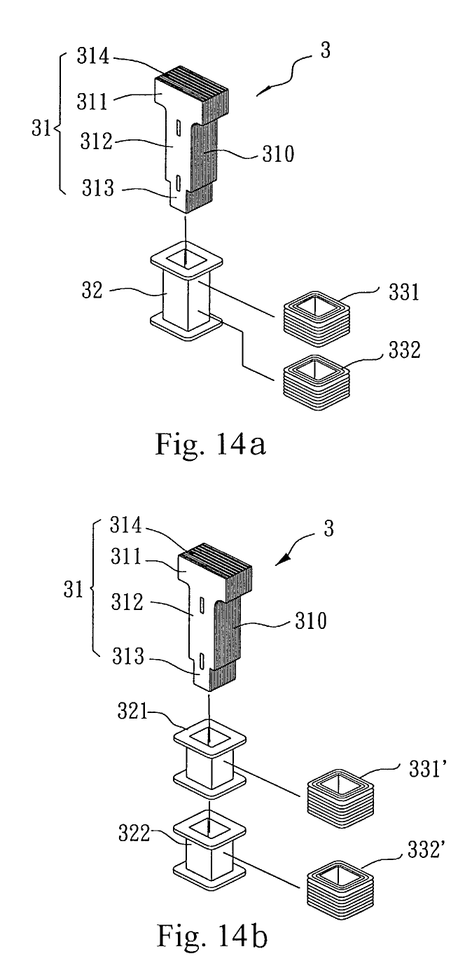

FIG. 14a shows an alternate form of the iron core module 3 shown in FIG. 2. According to this alternate form, the iron core module 3 is comprised of an iron core 31, an electrically insulative bushing 32 sleeved onto the iron core 31, and two windings 331 and 332 wound round the bushing 32 in reversed directions. Electric current may be connected to the winding 331 or 332 to induce a different direction of magnetic field. FIG. 14b shows another alternate form of the iron core module 3 shown in FIG. 2. According to this alternate form, the iron core module 3 is comprised of an iron core 31, two electrically insulative bushings 32 sleeved onto the iron core 31, and two windings 331 and 332 respectively wound round the bushings 32 in reversed directions.

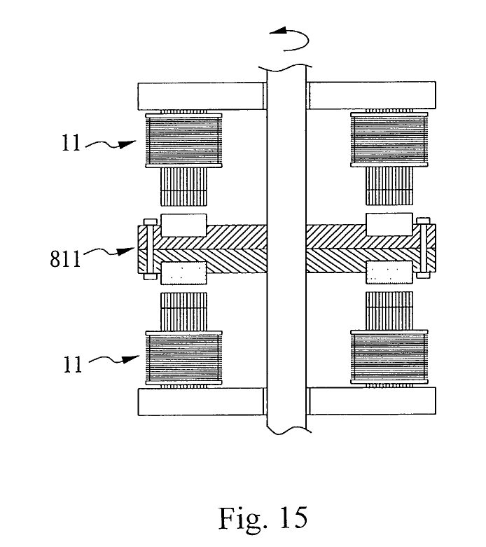

FIG. 15 shows a double layer structure in which two modularized stators 11 are arranged at two sides of a center rotor 811, which is formed of two rotors 81 (see FIG. 3) reversely arranged together. The two rotors 81 can be fastened together by screw nails, rivet means, welding, snap means, or any of a variety of conventional fastening means. Alternatively, two stators may be reversely fastened together and set between two rotors. Based on the modularized design of the present invention, three, four, or multiple stator and rotor sets may be arranged to form a motor.

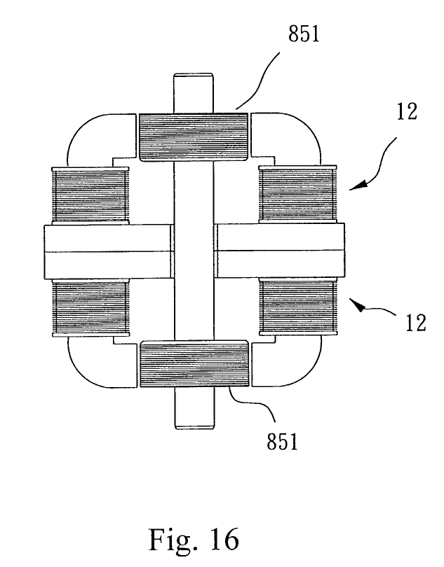

FIG. 16 shows two stators 12 reversely arranged together, and two rotors 851 arranged at two ends and radially aimed at the magnetic guide faces of the iron cores of the stators 12. The stators 12 used in this embodiment are same as that shown in FIG. 7. Based on this modularized design, three, four, or multiple stator and rotor sets may be arranged to form a motor.

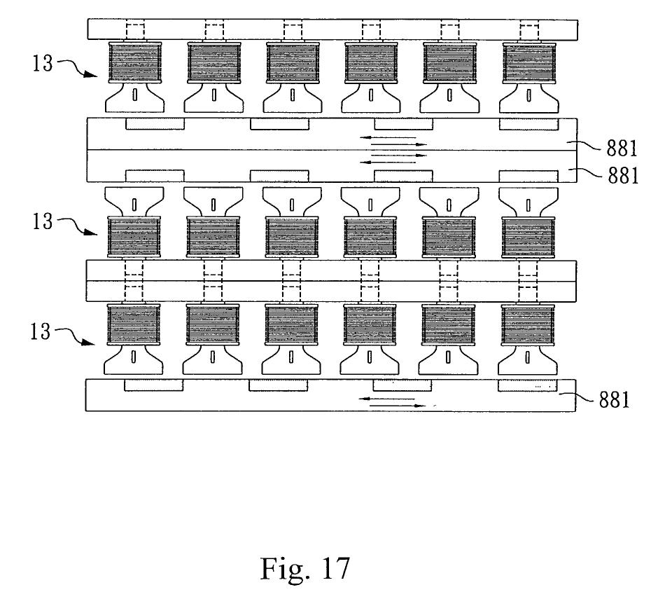

FIG. 17 shows a three-layer type linear motor constructed according to the present invention. According to this embodiment, stators 13 of FIG. 11 are reversely arranged to form the first and second layers, and the rotors 881 of the second and third layers are arranged together. Because every layer is modularized, a motor can easily made having multiple layers of stator and rotor set subject to the desired motor capacity or rated revolving speed.

Although the present invention has been explained in relation to its preferred embodiments, it is to be understood that many other possible modifications and variations can be made without departing from the spirit and scope of the invention as hereinafter claimed.

What is claimed is:

1. A modularized stator comprising:
a base made of magnetically conductive material, said base comprising a plurality of recessed locating holes on a surface thereof; and
a plurality of iron core modules respectively fixedly fastened to the recessed locating holes of said base, said iron core modules each comprising an iron core made of magnetically conductive material, said iron core comprising a top section forming a magnetic guide face, a bottom section fixedly fastened to one recessed locating hole of said base, and a middle section connected between said top section and said bottom section, an electrically insulative bushing mounted around the middle section of said iron core, and a winding wound round said electrically insulative bushing.

2. The modularized stator as claimed in claim 1, wherein said base is a disk-like member, and said recessed locating holes are equiangularly spaced on said base.

3. The modularized stator as claimed in claim 1, wherein said base is a flat, elongated member, and said recessed locating holes are equally spaced on said base and arranged in a line.

4. The modularized stator as claimed in claim 1, wherein said base is made of steel.

5. The modularized stator as claimed in claim 1, wherein the magnetic guide faces of the iron cores of said iron core modules extend in axial direction.

6. The modularized stator as claimed in claim 1, wherein the magnetic guide faces of the iron cores of said iron core modules extend in radial direction.

7. The modularized stator as claimed in claim 1, wherein the iron cores of said iron core modules are respectively formed of a stack of silicon steel plates.

8. The modularized stator as claimed in claim 1, wherein the iron cores of said iron core modules are respectively press-molded from iron powder.

9. The modularized stator as claimed in claim 1, wherein the electrically insulative bushings of said iron core modules are molded from plastics.
